(19) United States
(12) Patent Application Publication
(10) Pub. No.: US 2017/0205837 A1
(43) Pub. Date: Jul. 20, 2017

(54) PRESSURE REDUCING VALVE

(71) Applicant: Azbil Corporation, Tokyo (JP)

(72) Inventor: Masahiro KOMATSU, Tokyo (JP)

(73) Assignee: Azbil Corporation, Tokyo (JP)

(21) Appl. No.: 15/408,506

(22) Filed: Jan. 18, 2017

(30) Foreign Application Priority Data
Jan. 18, 2016 (JP) 2016-006836

(51) Int. Cl. G05D 16/06

(52) U.S. Cl. CPC G05D 16/0638

(57) ABSTRACT

A passage is defined which provides communication among an input port, a chamber, and an output-ports-connecting fluid path. A path, in the passage, from the input port to the chamber is defined as a primary-side communication path. A plug is pressure-inserted into the primary-side communication path in a direction from the input port side toward the chamber, which blocks the primary-side communication path.

### CROSS-REFERENCE TO RELATED APPLICATION

This application claims priority to Japanese Application No. 2016-006836 filed Jan. 18, 2016. This application is incorporated herein in its entirety.

### TECHNICAL FIELD

The present invention relates to a pressure reducing valve that outputs input primary-side fluid as secondary-side fluid down-regulated to a predetermined pressure.

### BACKGROUND

Conventionally, in a system termed as a process system such as a chemical plant and a power plant, a device is used to perform control which is driven by a pressure of fluid such as air, instead of electricity in order to prevent explosion.

When pressurized fluid supplied to this device is too high in pressure, a malfunction or a failure is ensued, and to prevent this, the pressure is reduced by a pressure reducing valve. That is, primary-side fluid from an air-pressure supply source is input, and secondary-side fluid obtained by down-regulating the input primary-side fluid to a predetermined pressure is output as the pressurized fluid. Such a pressure reducing valve of this type includes a diaphragm-type pressure reducing valve (see Japanese Unexamined Patent Application Publication No. H7-056638A, for example).

In the diaphragm-type pressure reducing valve, when a body includes a plurality of output ports of the secondary-side fluid (secondary-side piping connection ports), there are two methods for providing communication between a chamber that acts as a decompression chamber configured to decompress the primary-side fluid to the secondary-side fluid and each output port. One is a method (method 1) for defining a plurality of fluid paths directly communicating from each output port to the chamber. The other is a method (method 2) for defining a fluid path (output-ports-connecting fluid path) directly joining each output port, and at a certain midpoint along the path, defining a branched path communicating to the chamber.

In the diaphragm-type pressure reducing valve, when the above method 2 is adopted, as a processing method, generally, a passage is defined which goes through the output-ports-connecting fluid path from an outer wall of the body and reaches the chamber, after which a plug is pressure-inserted into an opening of the passage from an outer wall side of the body so as to close an unnecessary part.

FIG. 5 illustrates an example (vertical cross-sectional view) of a conventional diaphragm-type pressure reducing valve. FIG. 6 illustrates a cross-sectional view (plane cross-sectional view) taken along the line I-I in FIG. 5. In FIGS. 5 and 6, numeral 101 denotes an input port of the primary-side fluid, numeral 102 denotes a first output port of the secondary-side fluid, numeral 103 denotes a second output port of the secondary-side fluid, and numeral 104 denotes a chamber that acts as a decompression chamber configured to decompress the primary-side fluid to the secondary-side fluid, all of which are formed in a metal body 105.

In the pressure reducing valve 100, as the method for providing communication between the chamber 104 and each output port 102, 103, the method 2 described above is adopted.

That is, in the method 2 adopted in the pressure reducing valve 100, as illustrated in FIG. 7A, the first output port 102 and the second output port 103 are defined, and from this state, as illustrated in FIG. 7B, an output-ports-connecting fluid path 106 that provides communication between the first output port 102 and the second output port 103 is defined.

Next, as illustrated in FIG. 7C, a passage 107 is defined which goes through the output-ports-connecting fluid path 106 from an outer wall of the body 105 and reaches the chamber 104. Then, as illustrated in FIG. 7D, a plug 108 is pressure-inserted into an opening 107a of the passage 107 from the outer wall side of the body 105 to close an unnecessary part 107-1 of the passage 107.

In this way, in the method 2, at a certain midpoint of the output-ports-connecting fluid path 106, a branched path 107-2 in communication to the chamber 104 is defined.

In FIG. 5, numeral 109 denotes a filter, numeral 110 denotes a filter cover, numeral 111 denotes a poppet valve, numeral 112 denotes a diaphragm, numeral 113 denotes a pressure-regulating spring, and numeral 114 denotes a pressure-regulating knob. The diaphragm 112 is biased toward the chamber 104 side by the pressure-regulating spring 113. When the level of bias by the pressure-regulating spring 113 to the diaphragm 112 is regulated by the pressure-regulating knob 114, a pressure of the secondary-side fluid (pressurized fluid) output from the first output port 102 and the second output port 103 is set.

In the pressure reducing valve 100, a partition wall 115 is disposed between the input port 101 and the chamber 104, and a communication path 116 is defined which extends from an inner wall surface of the input port 101 into a space inside the filter cover 110. The primary-side fluid input from the input port 101 is curved after abutting against the partition wall 115, and enters, through the communication path 116, into the space inside the filter cover 110. Thereafter, the resultant fluid passes through the filter 109, goes through a gap of a valving element 111a of the poppet valve 111, and is guided, as the secondary-side fluid, into the chamber 104.

When the poppet valve 111 opens and closes an air supply port P1 and an air exhaust port P2, a pressure of the secondary-side fluid inside the chamber 104 is down-regulated to a predetermined pressure, the down-regulated secondary-side fluid is fed, through the branched path 107-2, to the output-ports-connecting fluid path 106, and output from the first output port 102 and the second output port 103.

However, in the pressure reducing valve 100, the passage 107 is defined which goes through the output-ports-connecting fluid path 106 from the outer wall of the body 105 and reaches the chamber 104, and the plug 108 is pressure-inserted from the outer wall side of the body 105 into the opening 107a of the passage 107. Thus, the pressure of the secondary-side fluid that flows in the output-ports-connecting fluid path 106 is directed in an outer wall direction of the body 105, and is applied to the plug 108. This may result in the plug 108 dropping off. That is, during a time when the pressure reducing valve 100 is in operation, the pressure at the output-ports-connecting fluid path 106 is higher, and thus, the pressure is applied in a direction to extract the plug 108. As a result, the plug 108 may fall out from the passage 107 toward outside the body 105.

It is noted that as illustrated in FIG. 8, it may be possible to define a fluid path 117 that communicates from the output port 102 to the chamber 104 and a fluid path 118 that communicates from the output port 103 to the chamber 104. That is, it may be possible to adopt the method 1 rather than the method 2. However, with the method 1, the body 105 needs to have a larger work surface, resulting in a cost increase.

That is, when the method 2 is adopted, as illustrated in FIG. 9, there are three work surfaces on the body 105. That is, one is a work surface of the input port 101, another is a work surface of the first output port 102 (wherein a work surface of the output-ports-connecting fluid path 106 is the same as that of the first output port 102), and the other is a work surface of the second output port 103 (wherein a work surface of the passage 107 is the same as that of the second output port 103). On the other hand, when the method 1 is adopted, as illustrated in FIG. 8, work surfaces of the fluid paths 117, 118 are added. This results in cause of a cost increase. Further, in an example illustrated in FIG. 8, the fluid paths 117, 118 intervene with the screw holes of the output ports 102, 103, and it is thus not possible to perform hole drilling processing.

The present invention has been achieved in order to resolve such a problem, and an object thereof is to provide a pressure reducing valve capable of preventing a plug from dropping off.

Summary In order to achieve such an object, the present invention provides a pressure reducing valve configured to output input primary-side fluid as secondary-side fluid down-regulated to a predetermined pressure. The pressure reducing valve includes an input port of the primary-side fluid, a first output port of the secondary-side fluid, a second output port of the secondary-side fluid, a chamber that acts as a decompression chamber configured to decompress the primary-side fluid to the secondary-side fluid, an output-ports-connecting fluid path that provides communication between the first output port and the second output port, a body having a passage that provides communication among the input port of the primary-side fluid, the chamber, and the output-ports-connecting fluid path, and a plug that is disposed inside the body and that blocks a primary-side communication path, the primary-side communication path being a path extending from the input port of the primary-side fluid in the passage to the chamber.

In the present invention, a passage that provides communication among the input port of the primary-side fluid, the chamber, and the output-ports-connecting fluid path is defined. A path from the input port of the primary-side fluid in the passage to the chamber is defined as a primary-side communication path. The primary-side communication path is blocked by the plug. In the present invention, during a time when the pressure reducing valve is in operation, a pressure of the primary-side fluid is constantly higher than that of the secondary-side fluid, and force is applied in a direction into which the plug is pushed. Thus, the plug is pressure-inserted into the primary-side communication path in a direction from the input port side toward the chamber, and, as a result, it is possible to ensure that the plug does not easily fall out to prevent the plug from dropping off.

According to the present invention, a passage that provides communication among the input port of the primary-side fluid, the chamber, and the output-ports-connecting fluid path is defined. A path from the input port of the primary-side fluid in the passage to the chamber is defined as a primary-side communication path. A communication path between the primary-side communication path and the chamber is blocked by a plug. Thus, during a time when the pressure reducing valve is in operation, force is constantly applied in a direction into which the plug is pushed. The plug is pressure-inserted into the primary-side communication path in a direction from the input port side toward the chamber, for example. It is thus possible to ensure that the plug does not easily fall out to prevent the plug from dropping off.

### BRIEF DESCRIPTION OF THE DRAWINGS

FIG. 1 is a vertical cross-sectional view illustrating a configuration of a pressure reducing valve according to an example of the present invention.

FIG. 2 is a cross-sectional view (plane cross-sectional view) taken along the line II-II in FIG. 1.

FIG. 3A is a diagram describing a method for providing communication between a chamber adopted in the pressure reducing valve and each output port (diagram illustrating a state where a first output port and a second output port are defined in a body).

FIG. 3B is a diagram illustrating a state where a body is formed with an output-ports-connecting fluid path that provides communication between the first output port and the second output port.

FIG. 3C is a diagram illustrating a state where the body is formed with a passage that provides communication among the input port, the chamber, and the output-ports-connecting fluid path.

FIG. 3D is a diagram illustrating a state where a plug is pressure-inserted into a primary-side communication path of a passage that provides communication among the input port, the chamber, and the output-ports-connecting fluid path.

FIG. 4 is a diagram illustrating a work surface on a body when the passage that provides communication among the input port, the chamber, and the output-ports-connecting fluid path is defined.

FIG. 5 is a vertical cross-sectional view illustrating an example of a conventional diaphragm-type pressure reducing valve.

FIG. 6 is a cross-sectional view (plane cross-sectional view) taken along the line I-I in FIG. 5.

FIG. 7A is a diagram describing a method for providing communication between a chamber adopted in the pressure reducing valve and each output port (diagram illustrating a state where the first output port and the second output port are defined in the body).

FIG. 7B is a diagram illustrating a state where the body is formed with the output-ports-connecting fluid path that provides communication between the first output port and the second output port.

FIG. 7C is a diagram illustrating a state where the body is formed with a passage extending from an outer wall of the body through the output-ports-connecting fluid path to the chamber.

FIG. 7D is a diagram illustrating a state where a plug is pressure-inserted into an opening of the passage from the outer wall side of the body.

FIG. 8 is a diagram illustrating a work surface on the body when a fluid path communicating from each output port to the chamber is defined.

FIG. 9 is a diagram illustrating a work surface on the body when a passage extending from the outer wall of the body through the output-ports-connecting fluid path to the chamber is defined.

### DETAILED DESCRIPTION

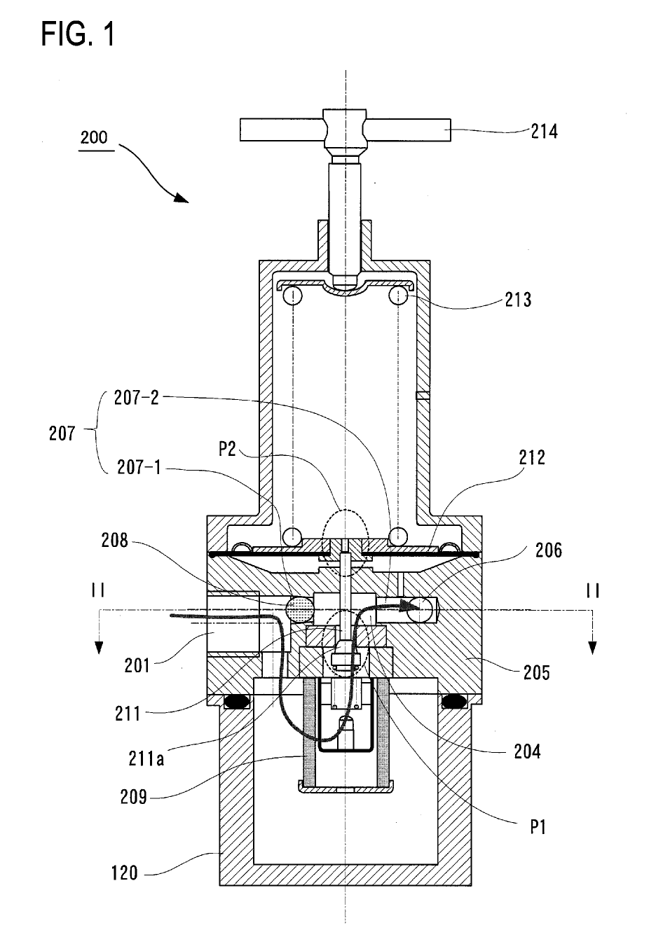

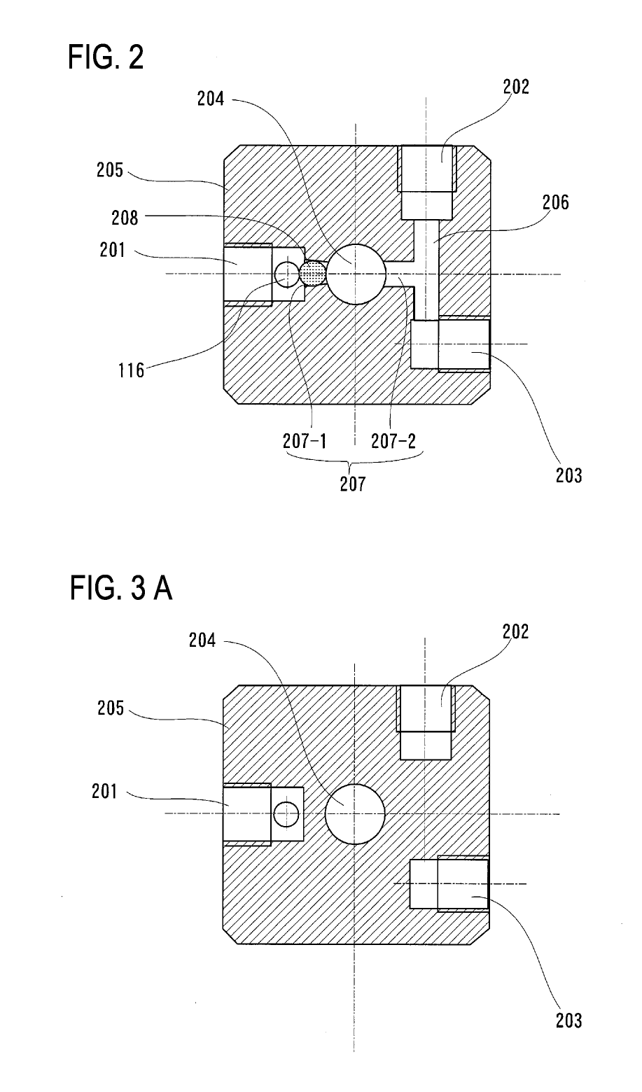

An example of the present invention will be described below in detail on the basis of drawings. FIG. 1 is a vertical cross-sectional view illustrating a configuration of a pressure reducing valve according to an embodiment of the present invention. FIG. 2 is a cross-sectional view (plane cross-sectional view) taken along the line II-II in FIG. 1.

In FIGS. 1 and 2, numeral 201 denotes an input port of primary-side fluid, numeral 202 denotes a first output port of secondary-side fluid, numeral 203 denotes a second output port of the secondary-side fluid, and numeral 204 denotes a chamber that acts as a decompression chamber configured to decompress the primary-side fluid to the secondary-side fluid, all of which are formed in a metal body 205.

In this pressure reducing valve 200, as a method for providing communication between the chamber 204 and each output port 202, 203, a method 3 different from the above methods 1 and 2 is adopted.

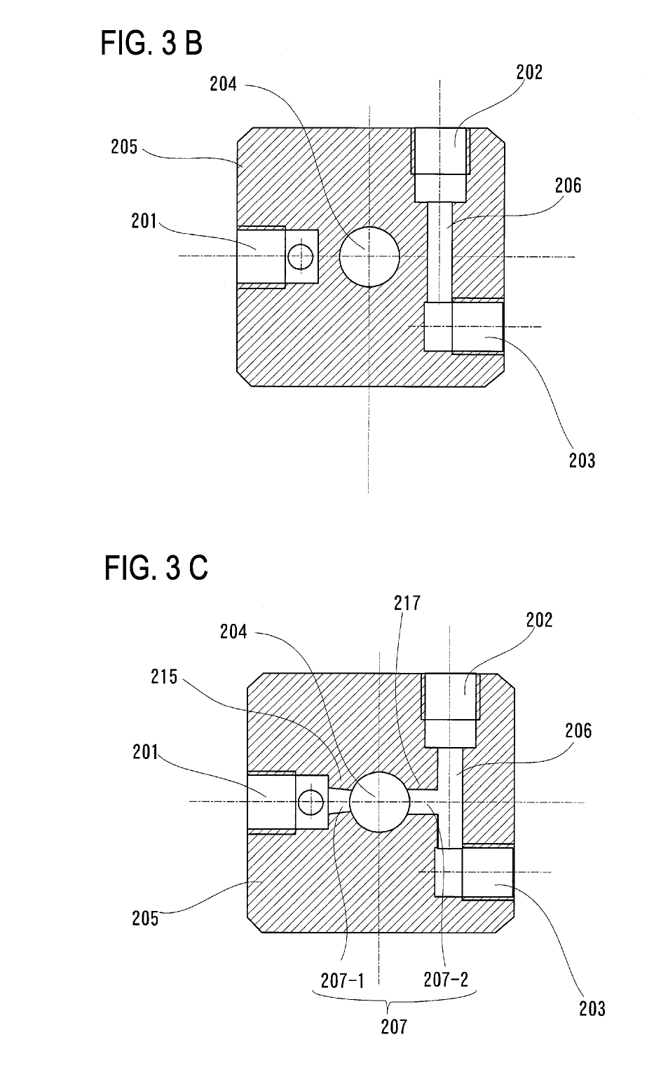

That is, in the method 3 adopted by the pressure reducing valve 200, as illustrated in FIG. 3A, the first output port 202 and the second output port 203 are defined, and from this state, as illustrated in FIG. 3B, an output-ports-connecting fluid path 206 that provides communication between the first output port 202 and the second output port 203 is defined.

Next, as illustrated in FIG. 3C, a partition wall 215 between the input port 201 and the chamber 204 is penetrated and a partition wall 217 between the chamber 204 and the output-ports-connecting fluid path 206 is penetrated. In this way, a passage 207 is defined which provides communication among the input port 201, the chamber 204, and the output-ports-connecting fluid path 206.

As illustrated in FIG. 3D, a path, in the passage 207, from the input port 201 to the chamber 204 is defined as a primary-side communication path 207-1. A plug 208 is pressure-inserted into the primary-side communication path 207-1 in a direction from the input port 201 side toward the chamber 204, which blocks the primary-side communication path 207-1. An inner wall surface of the primary-side communication path 207-1 is designed to reduce in diameter toward the chamber 204 such that the plug 208 does not fall out toward the chamber 204 side even when the plug 208 is pressure-inserted.

In this way, in the method 3, the primary-side communication path 207-1 is blocked by the plug 208, and at a certain midpoint of the output-ports-connecting fluid path 206, a branched path 207-2 is defined which provides communication with the chamber 204.

In FIG. 1, numeral 209 denotes a filter, numeral 120 denotes a filter cover, numeral 211 denotes a poppet valve, numeral 212 denotes a diaphragm, numeral 213 denotes a pressure-regulating spring, and numeral 214 denotes a pressure-regulating knob. The diaphragm 212 is biased toward the chamber 204 side by the pressure-regulating spring 213. When the level of bias by the pressure-regulating spring 213 to the diaphragm 212 is regulated by the pressure-regulating knob 214, a pressure of the secondary-side fluid (pressurized fluid) output from the first output port 202 and the second output port 203 is set.

In the pressure reducing valve 200, the primary-side communication path 207-1 between the input port 201 and the chamber 204 is blocked by the plug 208, and a communication path 216 is defined to extend from an inner wall surface of the input port 201 into a space inside the filter cover 210. The primary-side fluid input from the input port 201 is curved after abutting against the partition wall 215 in which the primary-side communication path 207-1 is blocked by the plug 208, and enters, through the communication path 116, into the space inside the filter cover 210. Thereafter, the resultant primary-side fluid passes through the filter 209, goes through a gap of a valving element 211a of the poppet valve 211, and is guided, as the secondary-side fluid, into the chamber 204.

When the poppet valve 211 opens and closes the air supply port P1 and the air exhaust port P2, a pressure of the secondary-side fluid inside the chamber 204 is down-regulated to a predetermined pressure, the down-regulated secondary-side fluid is fed, through the branched path 207-2, to the output-ports-connecting fluid path 206, and output from the first output port 202 and the second output port 203.

During a time when the pressure reducing valve 200 is in operation, a pressure of the primary-side fluid is constantly higher than that of the secondary-side fluid, and force is applied in a direction into which the plug 208 is pushed. That is, the plug 208 pressure-inserted into the primary-side communication path 207-1 from the input port 201 side receives force that further pushes the plug 208 toward the chamber 204 side. This ensures that the plug 208 does not easily fall out to prevent the plug 208 from dropping off.

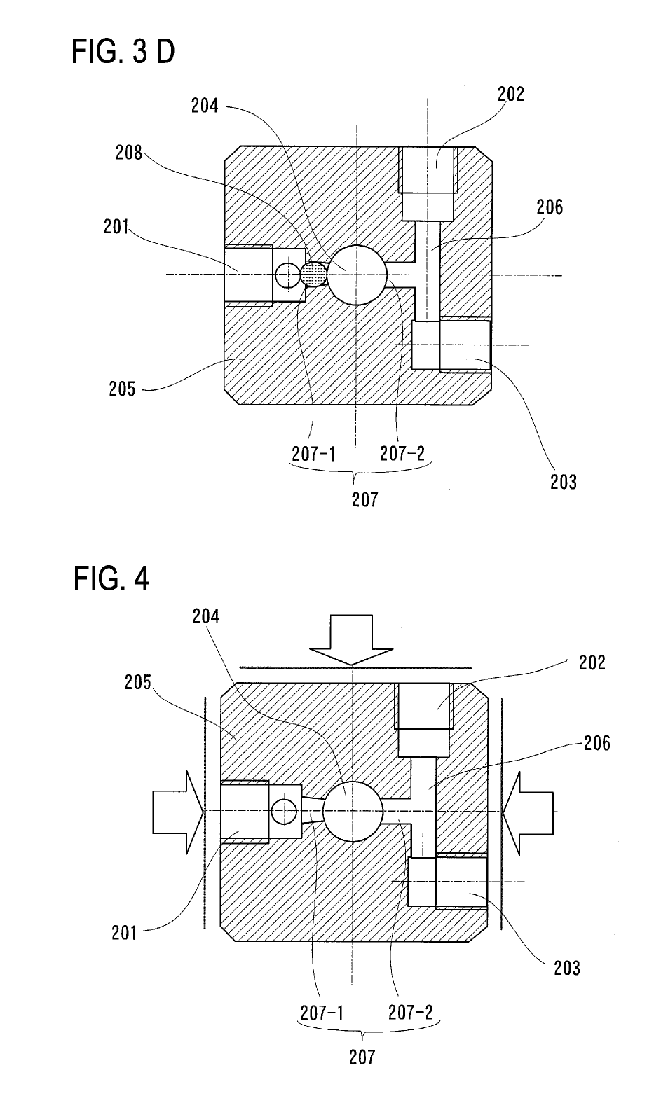

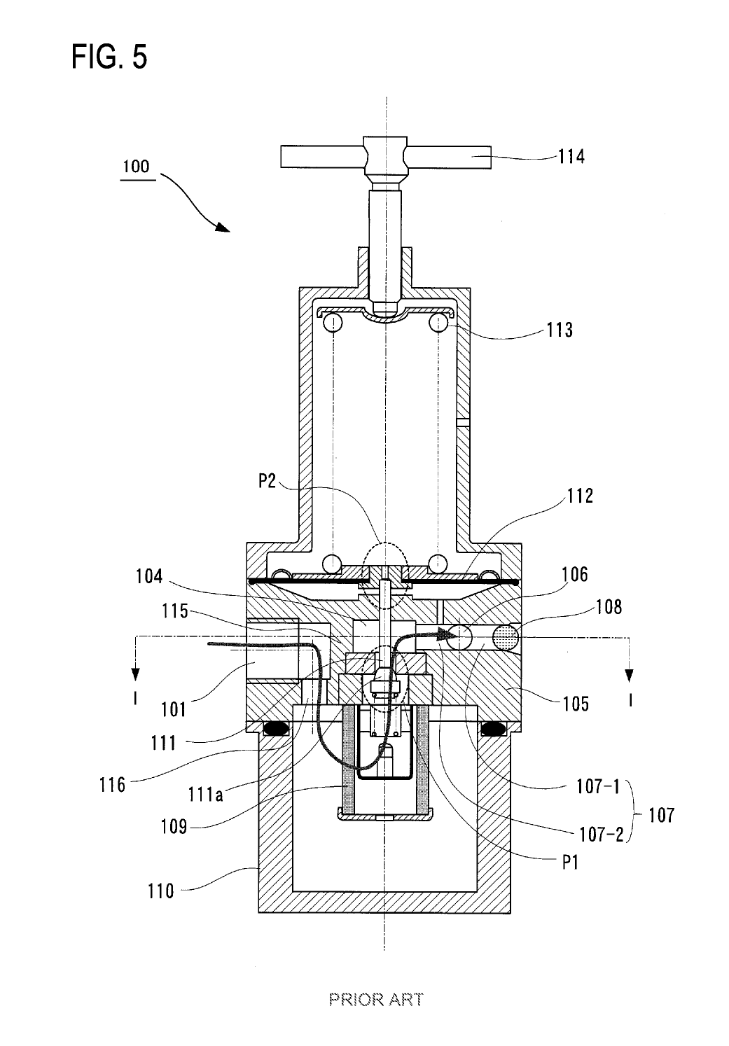

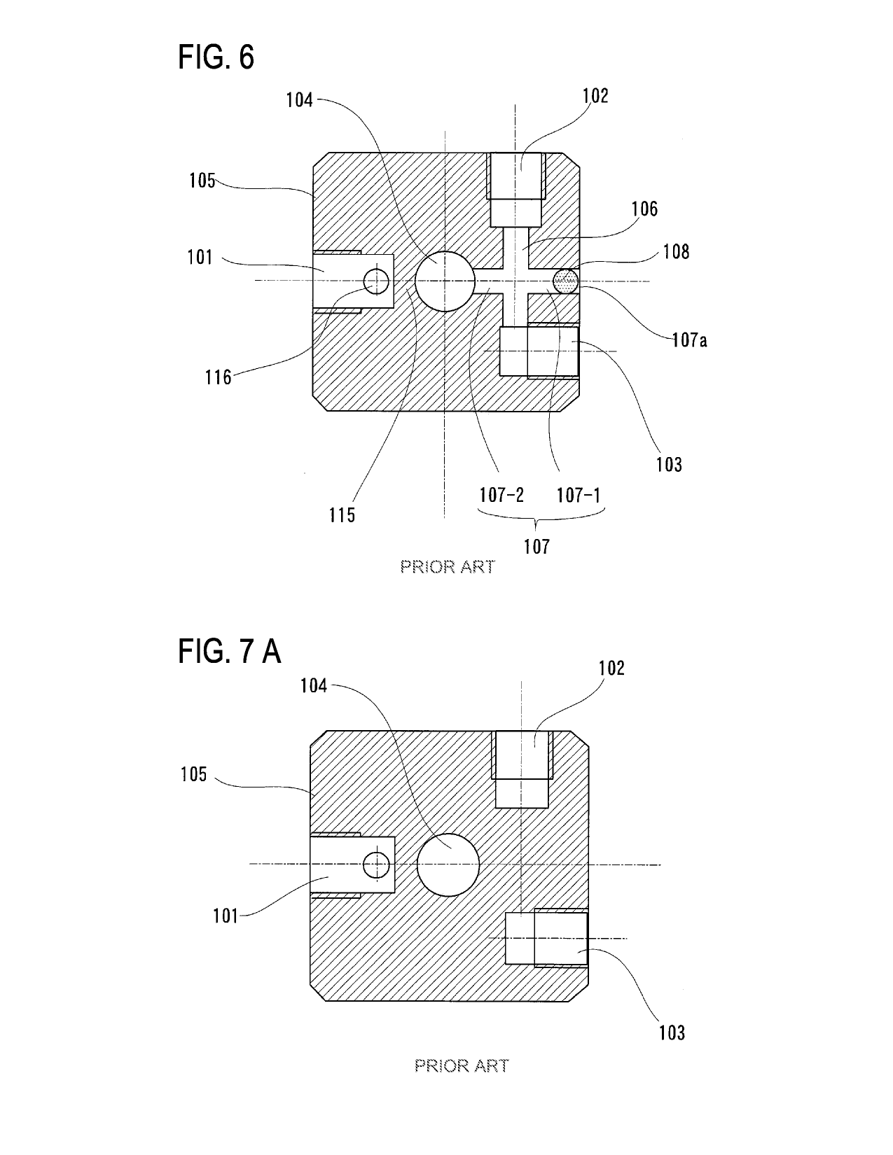

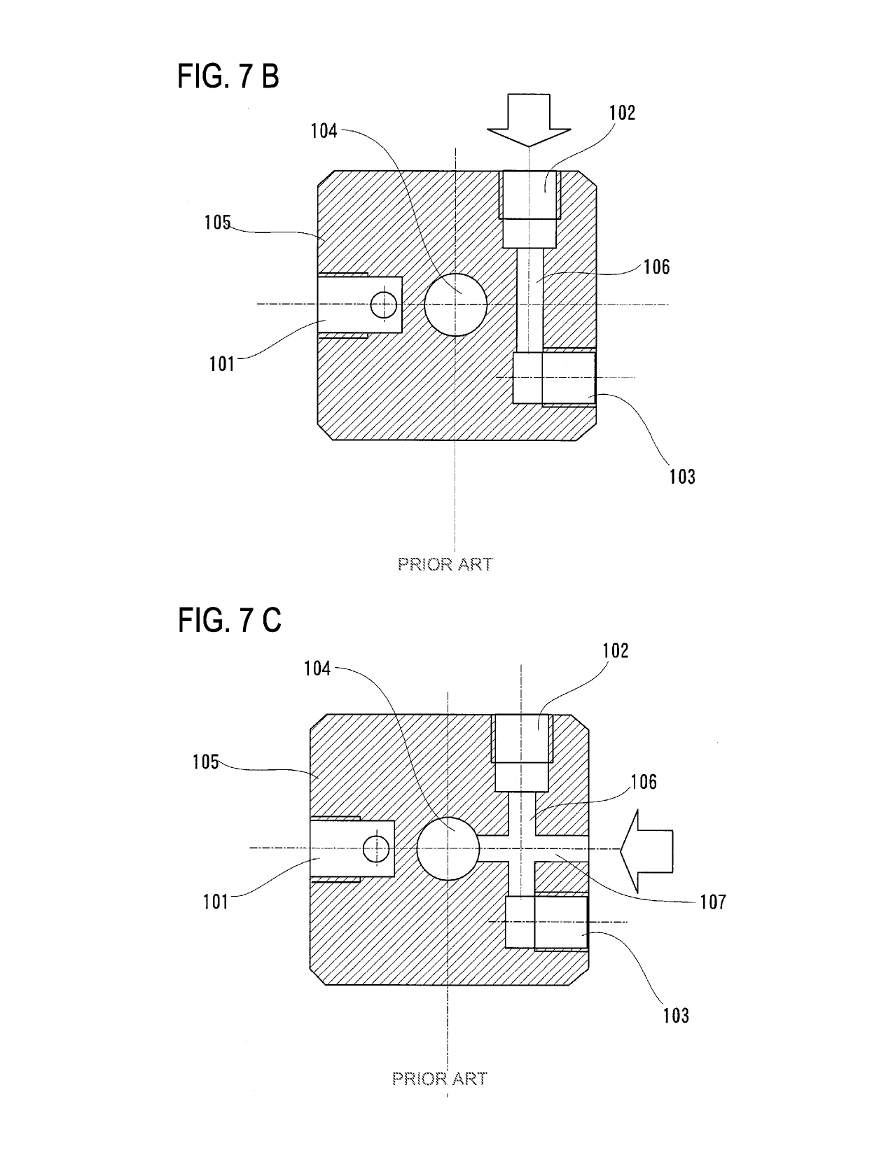

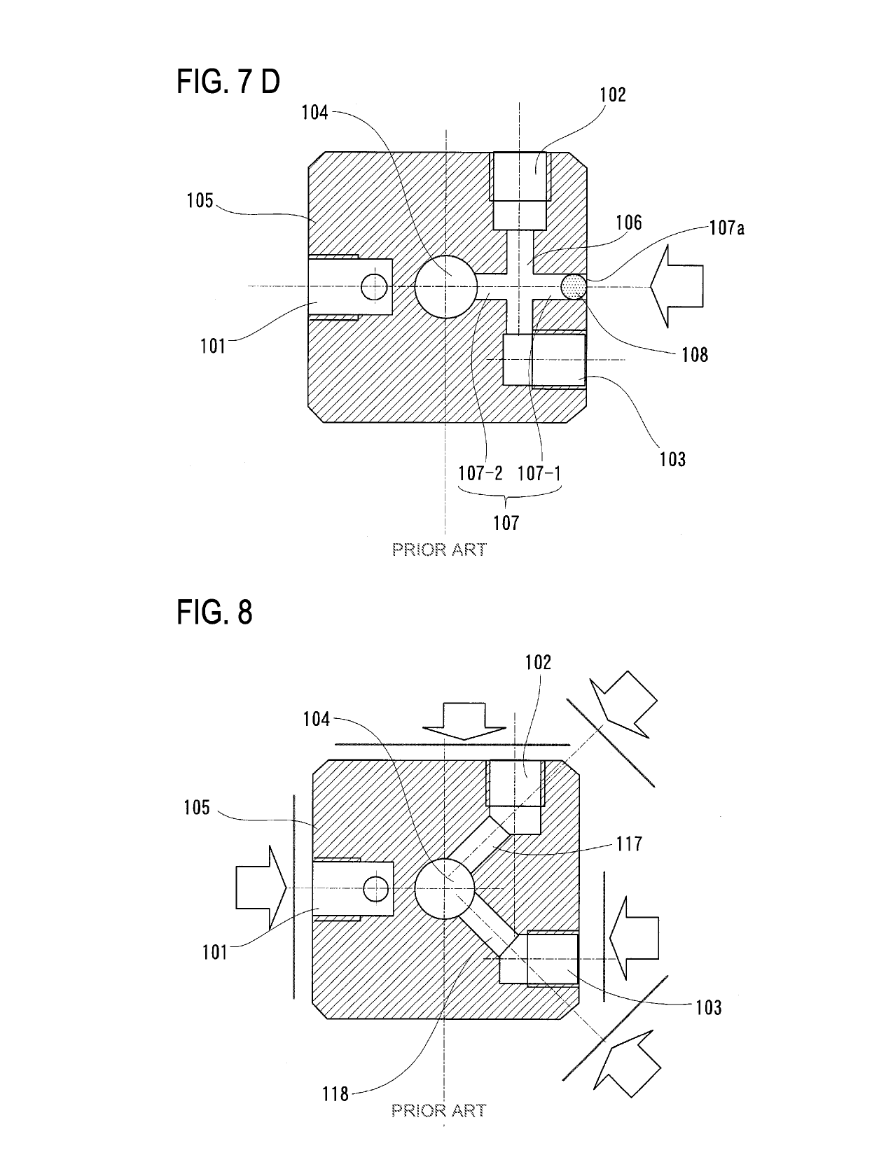

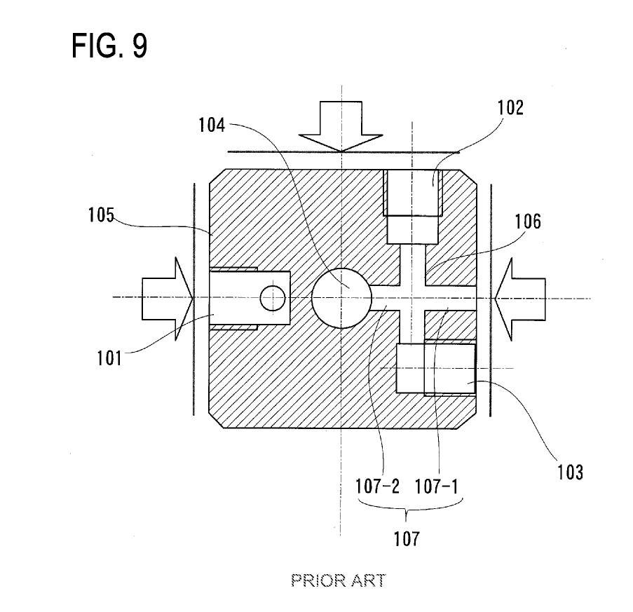

In the pressure reducing valve 200, a resistance to weather is improved because the plug 208 is not exposed to outside air. An outer wall of the body 205 has no opening (equivalent to the opening 107a of the conventional pressure reducing valve 100), and thus, reduction in size is easy. As illustrated in FIG. 4, the work surface of the passage 207 is the same as that of the input port 201, and thus, there is an advantage that the processing can be achieved with a relatively low cost (processing cost comparable to that of the conventional method 2).

In the above-described embodiment, the plug 208 is pressure-inserted from the input port 201 side into the primary-side communication path 207-1. However, the plug 208 may be fixed inside the primary-side communication path 207-1 by way of means such as bonding and screwing.

It may be also possible to pressure-insert the plug 208 from the chamber 204 side into the primary-side communication path 207-1. However, this is not easy and the plug 208 may fall out due to an air pressure. Thus, as in the above-described embodiment, the plug 208 preferably is pressure-inserted from the input port 201 side into the primary-side communication path 207-1.

The present invention is described with reference to the embodiment. However, the present invention is not limited to the above embodiment. It is possible to modify the configuration or details of the present invention in various ways understood by those skilled in the art within the scope of a technical idea of the present invention.

For example, the above embodiment provides a tapered structure that the inner wall surface of the primary-side communication path 207-1 is reduced in diameter toward the chamber 204. However, a stepped hole shape may also provide a similar effect. Various modes may be possible for a material of the plug 208, and a steel ball may be used, for example.

The present invention may be used as a pressure reducing valve for down-regulating a pressure of pressurized fluid, in a process system such as a chemical plant and a power plant.

What is claimed is:

1. A pressure reducing valve configured to output input primary-side fluid as secondary-side fluid down-regulated to a predetermined pressure, the pressure reducing valve comprising:
an input port of the primary-side fluid;
a first output port of the secondary-side fluid;
a second output port of the secondary-side fluid;
a chamber that acts as a decompression chamber configured to decompress the primary-side fluid to the secondary-side fluid;
an output-ports-connecting fluid path that provides communication between the first output port and the second output port;
a body including a passage that provides communication among the input port of the primary-side fluid, the chamber, and the output-ports-connecting fluid path; and
a plug disposed inside the body and that blocks a primary-side communication path, the primary-side communication path being a path extending from the input port of the primary-side fluid in the passage to the chamber.

2. The pressure reducing valve according to claim 1, wherein the plug is pressure-inserted into the primary-side communication path in a direction from the input port side toward the chamber.
